(19) United States
(12) Patent Application Publication
(10) Pub. No.: US 2008/0121294 A1
(43) Pub. Date: May 29, 2008

(54) Fluid Delivery System

(75) Inventor: Robert S. Hughes, Houston, TX (US)

Correspondence Address: DUANE MORRIS LLP, 3200 SOUTHWEST FREEWAY, SUITE 3150, HOUSTON, TX, 77027, US

(73) Assignee: Oceaneering International, Inc., Houston, TX (US)

(21) Appl. No.: 11/944,898

(22) Filed: Nov. 26, 2007

Related U.S. Application Data
(60) Provisional application No. 60/861,681, filed on Nov. 29, 2006.

(51) Int. Cl. F15B 13/00

(52) U.S. Cl. 137/605

(57) ABSTRACT

This invention relates to a fluid delivery system which can be used to deliver hydraulic fluid in a subsea hydraulic line. The invention described herein includes a body, a flow line extending in the body, and a plunger slideably mounted on the flow line.

### CROSS-REFERENCE TO RELATED APPLICATIONS

This application claims the benefit of Provisional Application Ser. No. 60/861,681, filed on Nov. 29, 2006.

### FIELD OF THE INVENTION

This invention relates to a fluid delivery system which can be used to deliver hydraulic fluid in a subsea hydraulic line. The invention described herein includes a body, a flow line extending in the body, and a plunger slideably mounted on the flow line.

### DESCRIPTION OF THE DRAWINGS

FIG. 1A is a cross-sectional view of a first preferred embodiment of the invention described herein.

FIG. 1B is an exploded isometric view of a first preferred embodiment of the invention described herein.

FIG. 1C is an enlarged cross-sectional view of a first end region of the embodiment shown in FIG. 1A.

FIG. 1D is an enlarged cross-sectional view of a second end region of the embodiment shown in FIG. 1A.

FIG. 2A is a cross-sectional view of a second preferred embodiment of the invention described herein.

FIG. 2B is a enlarged cross-sectional view of the second end region of the second preferred embodiment of the invention described herein.

FIG. 2C is a front view of a second end region of the embodiment shown in FIG. 1A.

FIG. 2D is a cross sectional isometric view of a second preferred embodiment of the invention described herein.

FIG. 3A is a side view of a third preferred embodiment of the invention described herein.

FIG. 3B is an isometric view of a third preferred embodiment of the invention described herein.

FIG. 4A is a cross sectional view of a protective housing containing multiple fluid delivery systems that are fully engaged with associated couplers.

FIG. 4B is a cross sectional view of a protective housing containing multiple fluid delivery systems that are fully disengaged with associated couplers.

FIG. 4C is a cross sectional view of a protective housing containing multiple fluid delivery systems that are separated from associated couplers.

FIG. 4D is a side view of a protective housing comprising multiple fluid delivery systems.

FIG. 4E is a front view of a protective housing comprising multiple fluid delivery systems.

FIG. 4F is a top view of a protective housing comprising multiple fluid delivery systems.

FIGS. 5A-5B depict the use of one or more embodiments of the inventions disclosed herein with a flying lead.

### DESCRIPTION OF THE PREFERRED EMBODIMENTS

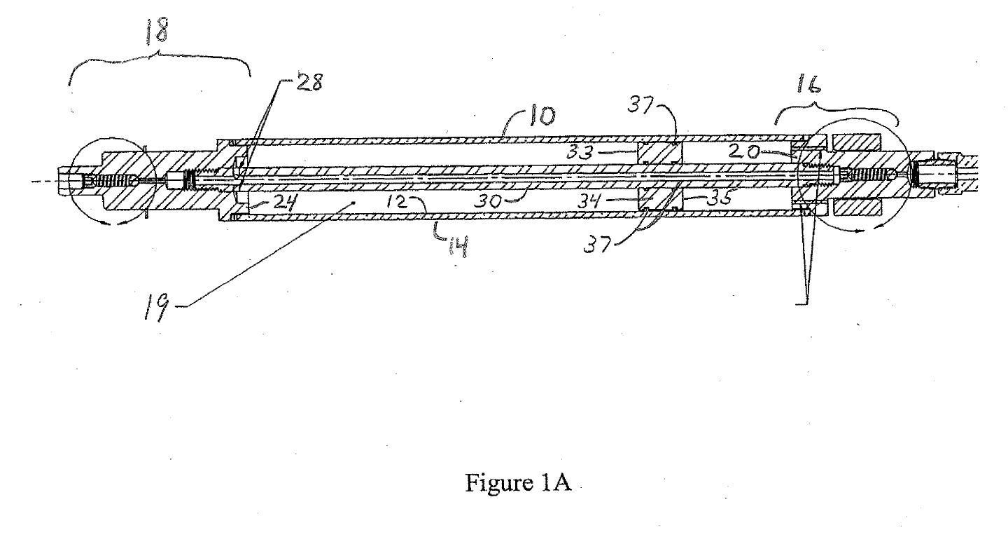

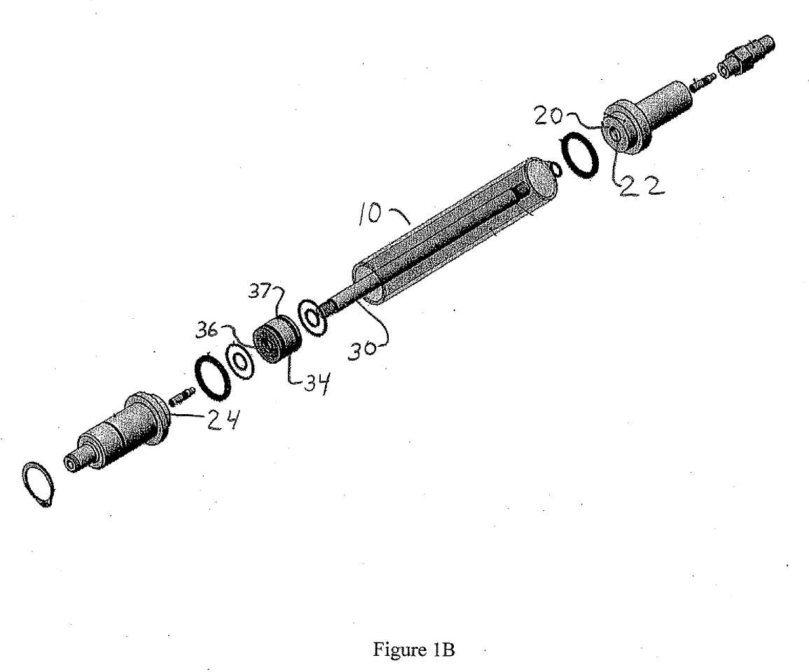

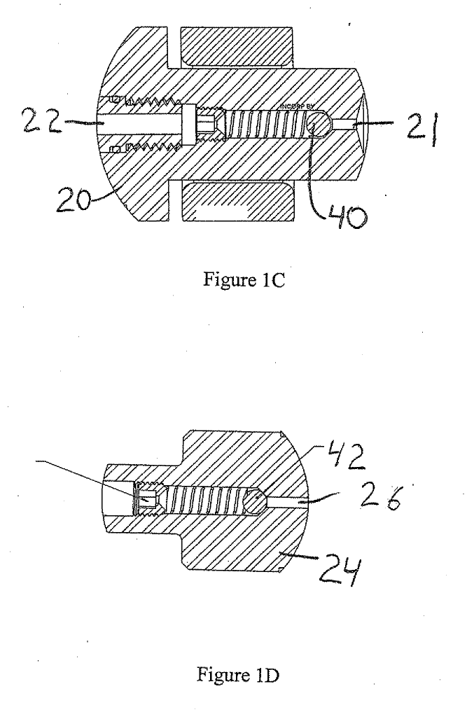

A first preferred embodiment of the fluid delivery system described herein comprises a body 10 comprising an inner surface 12, an outer surface 14, a first end region 16, and a second end region 18 opposite the first end region, to define an internal volume 19. The first preferred embodiment is shown in FIGS. 1A-1D. In a preferred embodiment, the body is cylindrical.

This first embodiment further comprises a first end plug 20 comprising an inlet port 22 and mounted in the first end region to separate the internal volume from an external region. In another preferred embodiment, the body comprises hydraulic fluid. In another preferred embodiment, the fluid delivery system further comprises a vent hole or vent channel 21 in the first end plug providing fluid communication between the internal volume and the external region.

This first preferred embodiment further comprises a second end plug 24 comprising an outlet port 26 and mounted in the second end region. The second end plug comprises a housing injection channel 28 permitting fluid communication between the outlet port and the internal volume.

This first preferred embodiment further comprises a flow line 30 extending from the inlet port to the outlet port and being in fluid communication with the injection channel to provide a fluid flowpath through the flow line and the injection channel, into the internal volume. In another preferred embodiment, the flow line is cylindrical.

This first preferred embodiment further comprises a plunger 34 slideably mounted on the flow line and sized to form a fluid tight seal between the flow line and the inner surface. The plunger has a first face 35 and a second face 33 opposite the first face. The plunger is configured such that it can slide along the flow line in response to a pressure differential across the plunger. In a preferred embodiment, the plunger is cylindrical. In another preferred embodiment, the plunger comprises a cylindrical channel 36 through which the flow line passes. In another preferred embodiment, the cylindrical channel is centrally located in the plunger.

In another preferred embodiment, a sealing member 37 is mounted on the plunger and positioned between the plunger and the inner surface. In another preferred embodiment, the sealing member is an o-ring.

In another preferred embodiment, a sealing member 37 is mounted on the plunger and positioned between the plunger and the flow line. In another preferred embodiment, the sealing member is an o-ring.

This first preferred embodiment further comprises a first check valve 40 installed in the flow line proximate the first end plug and oriented to permit fluid flow through the flow line toward the second end plug. This first embodiment further comprises a second check 42 valve installed in the flow line proximate the second end plug and oriented to permit fluid flow through the flow line away from the first end plug. In another preferred embodiment, the second check valve is configured to open in response to a predetermined pressure differential across the second check valve. In a preferred embodiment, the predetermined pressure differential is greater than the pressure differential required to move the plunger. In another preferred embodiment, the first and second check valves are spring loaded check valves. In another preferred embodiment, the fluid delivery system further comprises a hydraulic coupler mounted to the second end region.

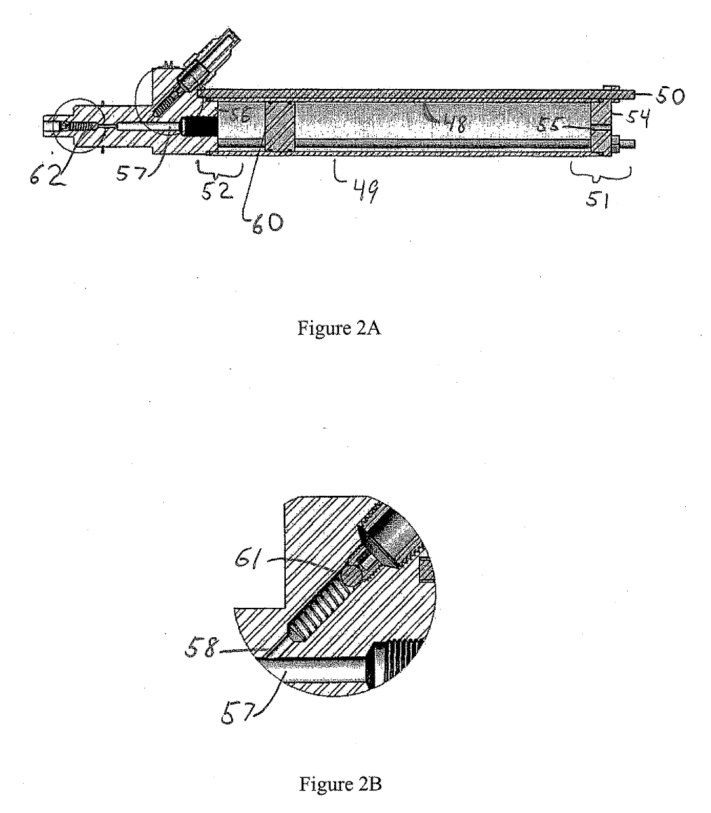

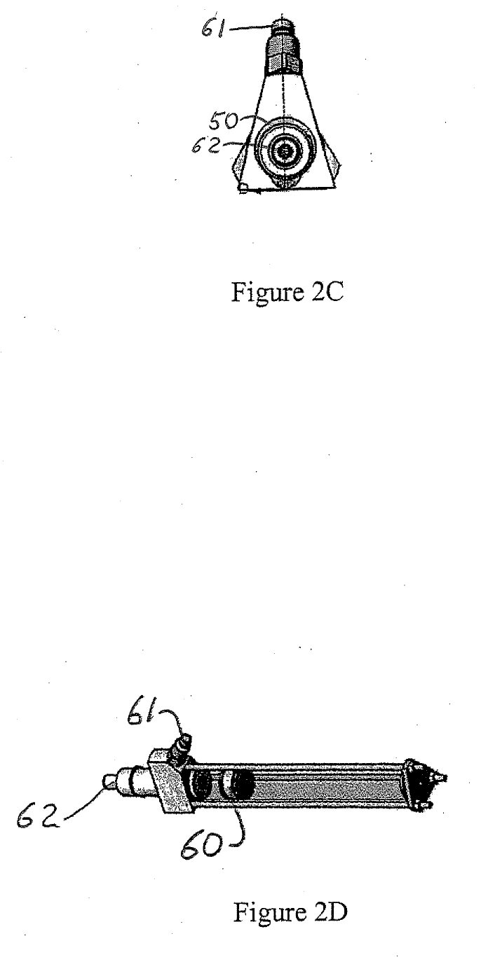

A second preferred embodiment of the fluid delivery system described herein comprises a body 50 comprising an inner surface 48, an outer surface 49, a first end region 51, and a second end region 52 opposite the first end region, to define an internal volume. The second preferred embodiment is shown in FIGS. 2A-2D. In a preferred embodiment, the body is cylindrical.

The second preferred embodiment further comprises a first end plug 54 comprising a vent port 55 and mounted in the first end region to separate the internal volume from an external region.

The second preferred embodiment further comprises a second end plug 56 mounted in the second end region. The second end plug comprises a housing injection channel 57 in fluid communication with the internal volume.

The second preferred embodiment further comprises a flow line 58 extending through the second end plug and intersecting the housing injection channel to provide a fluid flow path through the injection channel into the internal volume. In a preferred embodiment, the flow line intersects the housing injection channel at an acute angle. In another preferred embodiment, the acute angle is in the range of 30° to 60°.

The second preferred embodiment further comprises a plunger 60 slideably mounted in the internal volume and sized to form a fluid tight seal with the inner surface. The plunger has a first face and a second face opposite the first face. The plunger is configured such that it can move in the internal volume in response to a pressure differential across the plunger. In a preferred embodiment, the plunger is cylindrical.

The second preferred embodiment further comprises a first check valve 61 installed in the flow line proximate the first end plug and oriented to permit fluid flow through the flow line toward the injection channel.

The second preferred embodiment further comprises a second check valve 62 installed in the flow line proximate the second end plug and oriented to permit fluid flow through the injection channel away from the internal volume.

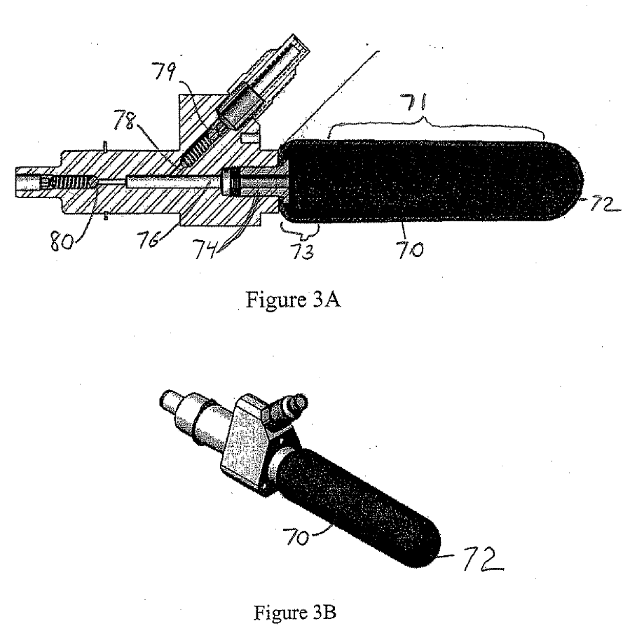

A third preferred embodiment of the fluid delivery system described herein comprises a flexible and collapsible body 70 comprising a cylindrical central region 71, a dome like first end region 72, and a second end region 73 opposite the first end region, to define an internal volume. The third preferred embodiment is shown in FIGS. 3A-3B. In a preferred embodiment, the body is made from an elastomeric material.

This third preferred embodiment further comprises an end plug 74 mounted in the second end region. The end plug comprises a housing injection channel 76 in fluid communication with the internal volume.

This third preferred embodiment further comprises a flow line 78 extending through the end plug and intersecting the housing injection channel to provide a fluid flow path through the injection channel, into the internal volume. In a preferred embodiment, the flow line intersects the housing injection channel at an acute angle. In another preferred embodiment, the acute angle is in the range of 30° to 60°.

This third preferred embodiment further comprises a first check valve 79 installed in the flow line proximate and oriented to permit fluid flow through the flow line toward the injection channel.

This third preferred embodiment further comprises a second check valve 80 installed in the flow line proximate the second end plug and oriented to permit fluid flow through the injection channel away from the internal volume.

One or more of the preferred embodiments of the invention disclosed herein is capable of being mated with a female coupling such as a National Coupler RS type hydraulic connector. Such hydraulic connectors are used in steel tube flying leads available from Oceaneering International, Inc. The bodies of the various embodiments of the invention disclosed herein can provide a small reservoir of hydraulic fluid that may be bled into the primary hydraulic line in the flying lead as pressure and temperature differentials increase.

Subsea flying leads have suffered from the ingress of a small amount of sea water as the coupler poppets open and close to normalize the hydraulic line internal pressure. The preferred embodiments of the invention disclosed herein may be used to eliminate sea water ingress by supplying hydraulic fluid as the pressure is normalized in the hydraulic lines. The preferred embodiments of the invention disclosed herein allow for hydraulic fluid to be bled into a flying lead as sea water occupies the void in the bodies created when hydraulic fluid is dispensed from the bodies.

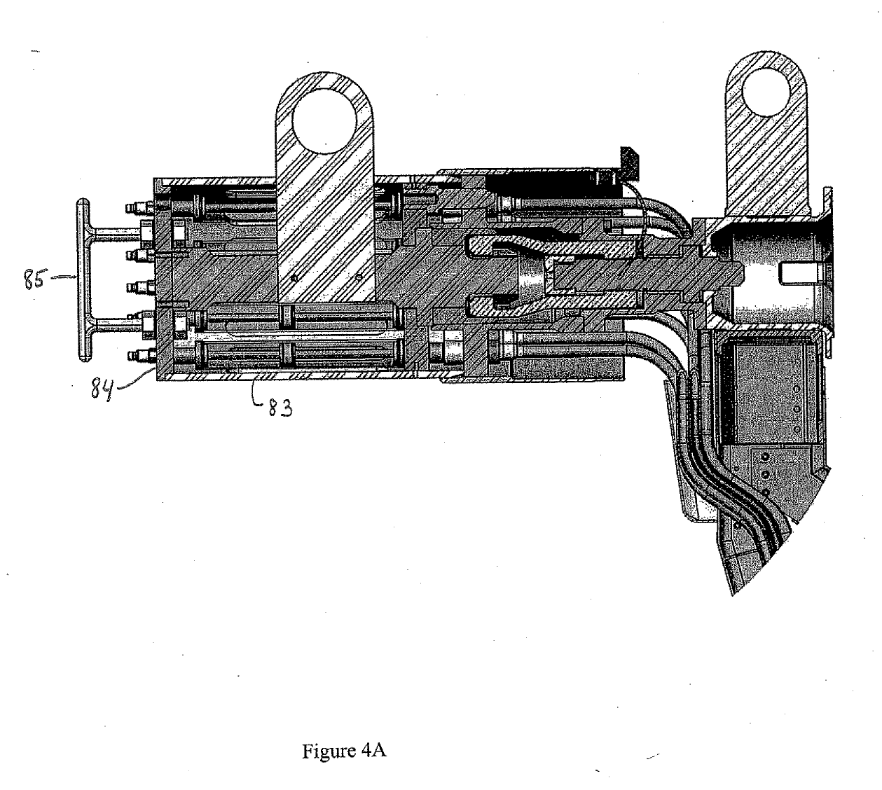

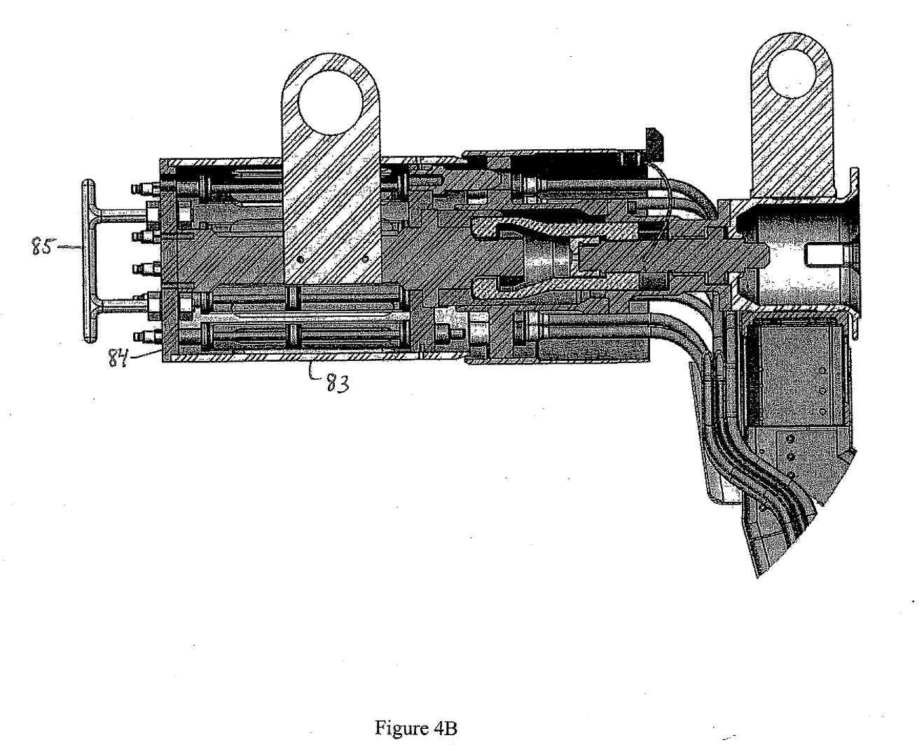

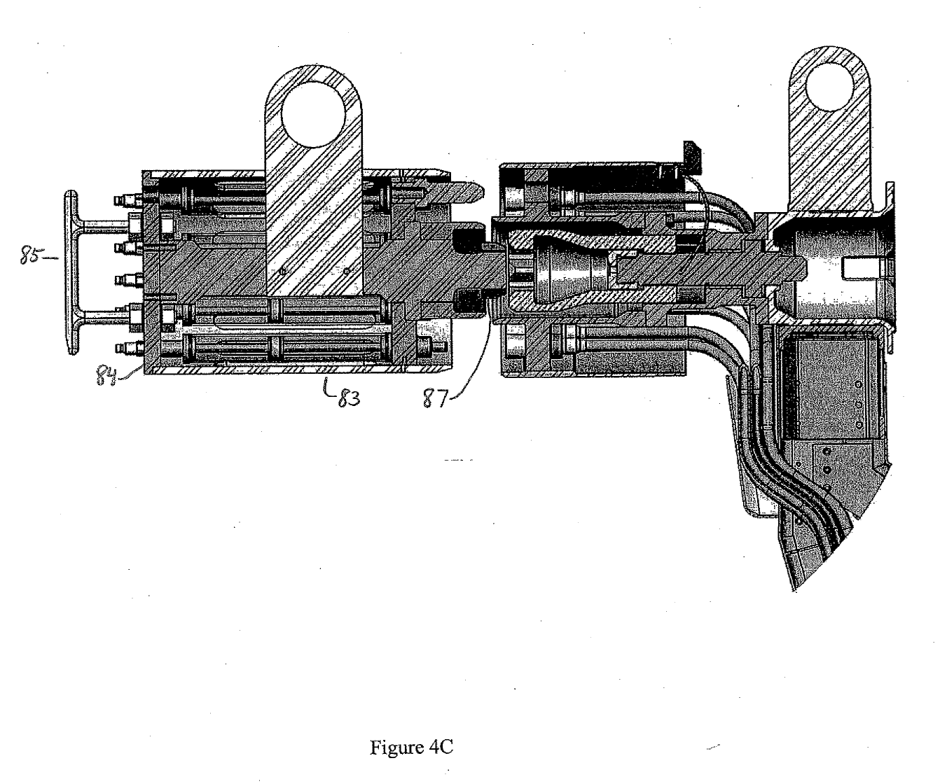

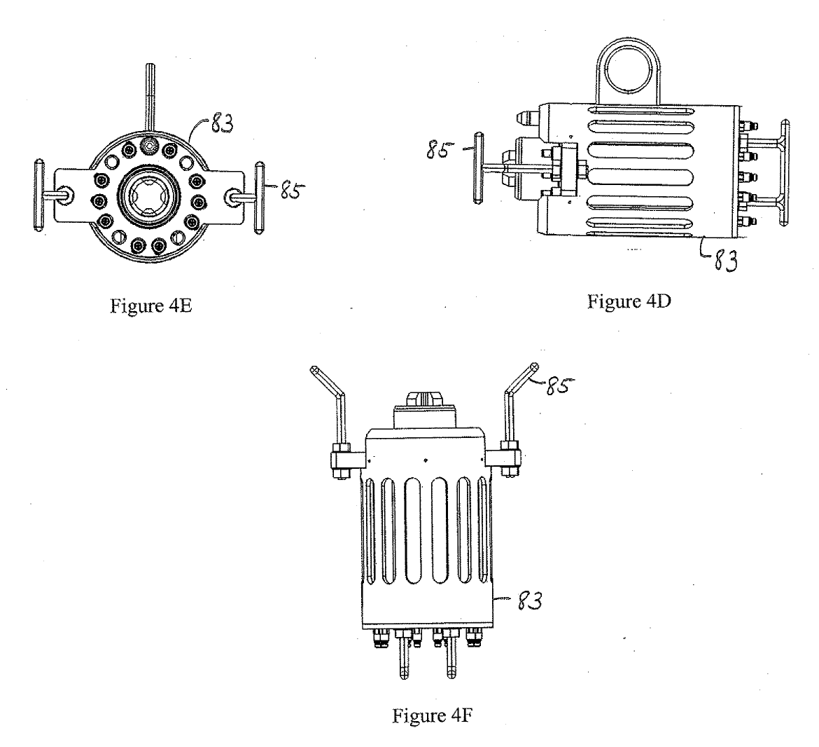

The preferred embodiments of the invention disclosed herein may be mounted in a protective housing 83 comprising a shroud and a rear plate 84 to protect the individual fluid delivery systems. Various embodiments of protective housings are shown in FIGS. 4A-4F. In FIG. 4A, the fluid delivery systems are fully engaged In FIG. 4B, the fluid delivery systems are fully disengaged In FIG. 4C, the fluid delivery systems are fully separated from the couplers.

The housing may further comprise a pad eye, or a handle 85, such as an ROV handle, a human grab handle, or a male latch mechanism designed to lock into a torque tool. The flying lead hardware 87 may also be incorporated into the housing. The fluid delivery system disclosed herein may also be used in conjunction with a junction plate.

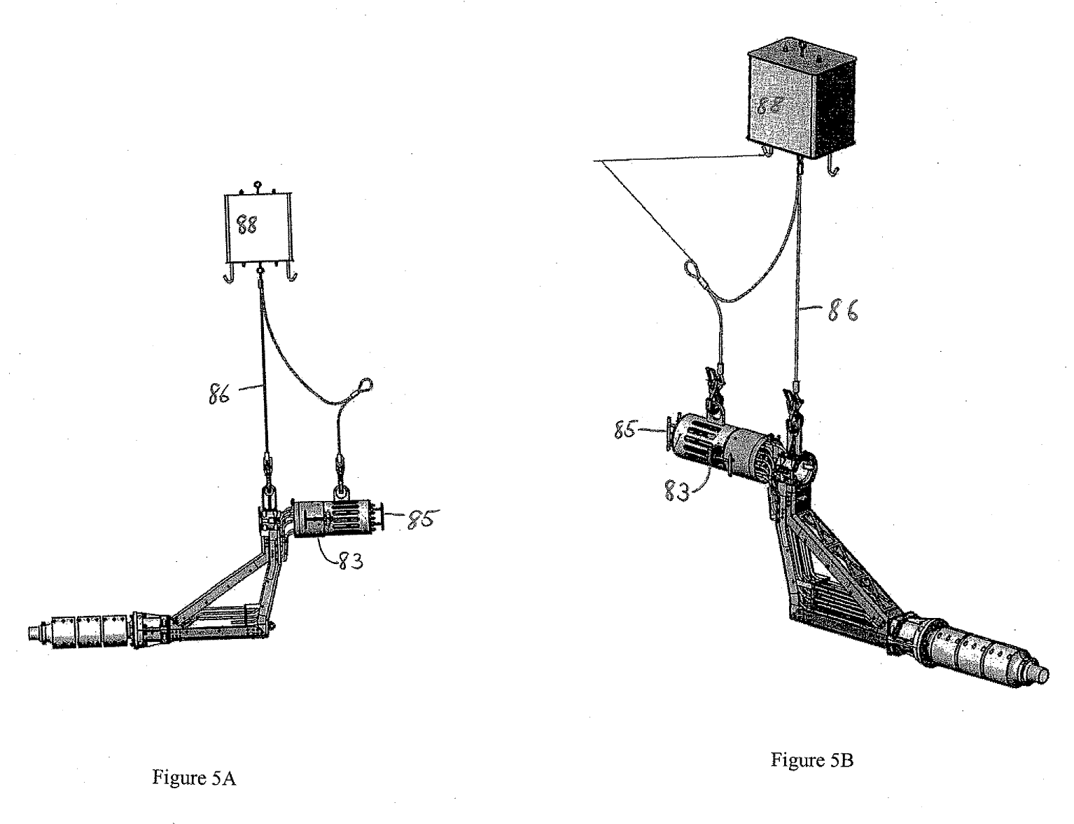

The various embodiments of the fluid delivery system disclosed herein may be charged or filled with hydraulic fluid prior to their installation. Integrated check valves and dripless quick connect hardware may be used to maintain cleanliness of the hydraulic fluid during the filling of the fluid delivery system disclosed herein. These fluid delivery systems may then be mated with a flying lead head at or above the sea surface. A latching mechanism 87 may be used to engage and secure the fluid delivery system disclosed herein. Once secure, the fluid delivery system's housing may be attached to a cable 86 which may then be attached to a flotation member 88 or other retrieval hardware. The entire flying lead assembly with the fluid delivery system attached may then be lowered to the sea floor. Various phases of installing a protective housing comprising the fluid delivery system described herein are shown in FIGS. 5A-5B.

An ROV may then engage a flying lead in a standard manner known to those persons of ordinary skill in the art of ROVs. A torque tool may be coupled to a torque bucket to actuate the flying lead coupling. The ROV may then reverse the latch, disconnecting the fluid delivery system from the flying lead and pushing the fluid delivery system out of the flying lead head. This will result in a de-mating of the fluid delivery system from its respective coupler. The housing of the fluid delivery system may be pushed or pulled the remainder of the way, using an ROV manipulator arm. The tethered fluid delivery system may then either fall away or be retrieved and stored by the ROV for removal and reuse.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A fluid delivery system, comprising:
(a) a body comprising an inner surface, an outer surface, a first end region, and a second end region opposite the first end region, to define an internal volume;
(b) a first end plug comprising an inlet port and mounted in the first end region to separate the internal volume from an external region;
(c) a second end plug comprising an outlet port and mounted in the second end region, said second end plug comprising a housing injection channel permitting fluid communication between the outlet port and the internal volume;
(d) a flow line extending from the inlet port to the outlet port and being in fluid communication with the injection channel to provide a fluid flowpath through the flow line and the injection channel, into the internal volume;
(e) a plunger slideably mounted on the flow line and sized to form a fluid tight seal between the flow line and the inner surface, said plunger having a first face and a second face opposite the first face, said plunger being configured such that it can slide along the flow line in response to a pressure differential across the plunger;
(f) a first check valve installed in the flow line proximate the first end plug and oriented to permit fluid flow through the flow line toward the second end plug; and
(g) a second check valve installed in the flow line proximate the second end plug and oriented to permit fluid flow through the flow line away from the first end plug.

2. The fluid delivery system of claim 1, wherein the body and the flow line are cylindrical.

3. The fluid delivery system of claim 2, wherein the plunger comprises a cylindrical channel through which the flow line passes.

4. The fluid delivery system of claim 3, wherein the cylindrical channel is centrally located in the plunger.

5. The fluid delivery system of claim 1, further comprising a sealing member mounted on the plunger and positioned between the plunger and the inner surface.

6. The fluid delivery system of claim 5, wherein the sealing the sealing member is an o-ring.

7. The fluid delivery system of claim 5, further comprising a sealing member mounted on the plunger and positioned between the plunger and the flow line.

8. The fluid delivery system of claim 7, wherein the sealing member is an o-ring.

9. The fluid delivery system of claim 1, wherein the body comprises hydraulic fluid.

10. The fluid delivery system of claim 1, wherein the second check valve is configured to open in response to a predetermined pressure differential across the second check valve.

11. The fluid delivery system of claim 1, wherein the first and second check valves are spring loaded check valves.

12. The fluid delivery system of claim 1, further comprising a vent channel in the first end plug providing fluid communication between the internal volume and the external region.

13. The fluid delivery system of claim 1, further comprising a hydraulic coupler mounted to the second end region.

14. A fluid delivery system, comprising:
(a) a body comprising an inner surface, an outer surface, a first end region, and a second end region opposite the first end region, to define an internal volume;
(b) a first end plug comprising a vent port and mounted in the first end region to separate the internal volume from an external region;
(c) a second end plug mounted in the second end region, said second end plug comprising a housing injection channel in fluid communication with the internal volume;
(d) a flow line extending through the second end plug and intersecting the housing injection channel to provide a fluid flowpath through the injection channel, into the internal volume;
(e) a plunger slideably mounted in the internal volume and sized to form a fluid tight seal with the inner surface, said plunger having a first face and a second face opposite the first face, said plunger being configured such that it can move in the internal volume in response to a pressure differential across the plunger;
(f) a first check valve installed in the flow line proximate the first end plug and oriented to permit fluid flow through the flow line toward the injection channel; and
(g) a second check valve installed in the flow line proximate the second end plug and oriented to permit fluid flow through the injection channel away from the internal volume.

15. The fluid delivery system of claim 14, wherein the body and the plunger are cylindrical.

16. The fluid delivery system of claim 14, further comprising a sealing member mounted on the plunger and positioned between the plunger and the inner surface.

17. The fluid delivery system of claim 14, wherein the second check valve is configured to open in response to a predetermined pressure differential across the second check valve.

18. A fluid delivery system, comprising:
(a) a flexible and collapsible body comprising a cylindrical central region, a dome like first end region, and a second end region opposite the first end region, to define an internal volume;
(b) an end plug mounted in the second end region, said end plug comprising a housing injection channel in fluid communication with the internal volume;
(c) a flow line extending from the inlet port to the outlet port and intersecting the housing injection channel to provide a fluid flowpath through the injection channel, into the internal volume;
(d) a first check valve installed in the flow line proximate and oriented to permit fluid flow through the flow line toward the injection channel; and
(e) a second check valve installed in the flow line proximate the second end plug and oriented to permit fluid flow through the injection channel away from the internal volume.

19. The fluid delivery system of claim 18, wherein the first and second check valves are spring loaded check valves.

20. The fluid delivery system of claim 18, wherein the body is made from an elastomeric material.

21. The fluid delivery system of claim 18, wherein the body comprises hydraulic fluid.

22. The fluid delivery system of claim 18, wherein the flow line intersects the housing injection channel at an acute angle.
